(19) United States
(12) Patent Application Publication
(10) Pub. No.: US 2017/0329260 A1
(43) Pub. Date: Nov. 16, 2017

(54) TRANSFER ROLLER, AND PRODUCTION METHOD FOR THE TRANSFER ROLLER

(71) Applicant: SUMITOMO RUBBER INDUSTRIES, LTD., Kobe-shi (JP)

(72) Inventor: Yusuke TANIO, Kobe-shi (JP)

(73) Assignee: SUMITOMO RUBBER INDUSTRIES, LTD., Kobe-shi (JP)

(21) Appl. No.: 15/487,070

(22) Filed: Apr. 13, 2017

(30) Foreign Application Priority Data
May 10, 2016 (JP) 2016-094776
Jul. 11, 2016 (JP) 2016-136911

(51) Int. Cl. G03G 15/16; B29C 47/88; B29C 47/00; B29K 507/04; B29K 33/18; B29L 31/00

(52) U.S. Cl. CPC G03G 15/162; B29C 47/0042; B29C 47/881; B29C 47/0023; B29K 2033/18; B29K 2995/0005; B29K 2995/007; B29L 2031/767; B29K 2507/04

(57) ABSTRACT

An inventive transfer roller (1) is made of a foam formed from an electrically conductive rubber composition containing an electrically conductive rubber, a crosslinking component, and a foaming agent including OBSH and 0.25 to 2.5 parts by mass of sodium hydrogen carbonate based on 1 part by mass of OBSH, and has an Asker-C hardness of not lower than 25 degrees and not higher than 35 degrees and an average foam cell diameter of not greater than 120 μm. Therefore, the transfer roller is flexible with a lower rubber hardness, and has smaller foam cell diameters. An inventive production method includes the steps of: forming the electrically conductive rubber composition into a tubular body; and maintaining the tubular body at a temperature of not lower than 120° C. and not higher than 140° C. to foam the rubber by a single-stage foaming process.

### TECHNICAL FIELD

The present invention relates to a transfer roller, and to a production method for the transfer roller.

### BACKGROUND ART

In an electrophotographic image forming apparatus such as a laser printer, an electrostatic copying machine, a plain paper facsimile machine or a printer-copier-facsimile multifunction machine, an image is generally formed on a surface of a sheet such as a paper sheet or a plastic film through the following process steps.

First, a photoelectrically conductive surface of a photoreceptor body is evenly electrically charged (charging step). Then, the surface of the photoreceptor body is exposed to light, whereby an electrostatic latent image corresponding to an image to be formed on the sheet is formed on the surface of the photoreceptor body (exposing step).

In turn, toner (minute color particles) preliminarily electrically charged at a predetermined potential is brought into contact with the surface of the photoreceptor body. Thus, the toner selectively adheres to the surface of the photoreceptor body according to the potential pattern of the electrostatic latent image, whereby the electrostatic latent image is developed into a toner image (developing step).

Subsequently, the toner image formed by the development is transferred onto the surface of the sheet (transfer step), and fixed to the surface of the sheet (fixing step). Thus, the image is formed on the surface of the sheet.

Further, toner remaining on the surface of the photoreceptor body after the transfer of the toner image is removed, whereby the photoreceptor body is ready for the next image formation (cleaning step).

The transfer step is performed by directly transferring the toner image from the surface of the photoreceptor body to the surface of the sheet or by primarily transferring the toner image onto a surface of an image carrier and secondarily transferring the toner image onto the surface of the sheet.

In the transfer step, an electrically conductive transfer roller of a rubber foam is generally used for transferring the toner image onto the surface of the sheet or onto the surface of the image carrier.

The transfer roller is generally formed from an electrically conductive rubber composition which contains a rubber, a crosslinking component for crosslinking the rubber, and a foaming agent thermally decomposable to generate gas for foaming the rubber, and is imparted with the electrical conductivity by using an ion conductive rubber as the rubber or by blending an electrically conductive agent.

The transfer roller is produced by forming the electrically conductive rubber composition into a tubular body and heating the tubular body to foam and crosslink the rubber.

In recent years, the transfer roller is required to be flexible with the lowest possible rubber hardness and have a smoother outer peripheral surface with the smallest possible foam cell diameters for higher-quality image formation of the image forming apparatus.

For example, azodicarbonamide (ADCA) and 4,4′-oxybisbenzenesulfonylhydrazide (OBSH) are used as the foaming agent (Patent Document 1 and the like).

In comparison between these foaming agents, OBSH tends to provide smaller-diameter foam cells than ADCA. Where a foam having smaller-diameter foam cells is to be produced, OBSH is generally selected as the foaming agent.

However, OBSH also functions as a crosslinking accelerating agent. Therefore, when a formed product is heated, for example, a rubber crosslinking reaction proceeds predominantly over the foaming by the decomposition of OBSH. Gas generated in excess by the decomposition does not easily penetrate through rubber cell walls to the outside of the foam, but is incorporated in the individual foam cells. As a result, the foam cells tend to each have a greater cell diameter.

If OBSH is used alone as the foaming agent, therefore, it is impossible to produce a transfer roller which is flexible with a lower rubber hardness and has smaller foam cell diameters to satisfy the recent requirements.

### CITATION LIST

### Patent Document

Patent Document 1: JP2001-227532A

Patent Document 2: JP2002-113734A

### SUMMARY OF THE INVENTION

### Problem to be Solved by the Invention

It is an object of the present invention to provide a transfer roller which is flexible with a lower rubber hardness and has smaller foam cell diameters, and to provide a production method for the transfer roller.

### Solution to Problem

According to an inventive aspect, there is provided a transfer roller comprising a foam formed from an electrically conductive rubber composition containing a rubber component, a crosslinking component for crosslinking the rubber component, and a foaming agent including OBSH and not less than 0.25 parts by mass and not greater than 2.5 parts by mass of sodium hydrogen carbonate based on 1 part by mass of OBSH for foaming the rubber component, the transfer roller having an Asker-C hardness of not lower than 25 degrees and not higher than 35 degrees and an average foam cell diameter of not greater than 120 μm.

According to another inventive aspect, there is provided a transfer roller production method, which includes the steps of: extruding the electrically conductive rubber composition into a tubular body; and maintaining the tubular body at a temperature of not lower than 120° C. and not higher than 140° C. in a vulcanization can by application of pressurized steam to foam the electrically conductive rubber composition at a single stage.

According to further another inventive aspect, there is provided a transfer roller production method, which includes the steps of extruding the electrically conductive rubber composition into a tubular body; and, while continuously transporting the tubular body through a continuous crosslinking apparatus including a microwave crosslinking device and a hot air crosslinking device, maintaining the tubular body at a temperature of not lower than 120° C. and not higher than 140° C. to foam the electrically conductive rubber composition at a single stage.

### Effects of the Invention

According to the present invention, the transfer roller is provided which is flexible with a lower rubber hardness and has smaller foam cell diameters. The production methods for the transfer roller are also provided.

### BRIEF DESCRIPTION OF THE DRAWINGS

FIG. 1 is a perspective view illustrating an exemplary transfer roller according to one embodiment of the present invention.

FIG. 2 is a block diagram schematically illustrating a continuous crosslinking apparatus to be used for production of the inventive transfer roller.

### EMBODIMENTS OF THE INVENTION

### <<Transfer Roller>>

An electrically conductive rubber composition to be used as a material for an inventive transfer roller contains a rubber component, a crosslinking component for crosslinking the rubber component, and a foaming agent including OBSH and not less than 0.25 parts by mass and not greater than 2.5 parts by mass of sodium hydrogen carbonate based on 1 part by mass of OBSH for foaming the rubber component.

A transfer roller which is flexible with a lower rubber hardness and has smaller foam cell diameters can be produced from the electrically conductive rubber composition.

With the use of the electrically conductive rubber composition, more specifically, the transfer roller can be produced as having an Asker-C hardness of not lower than 25 degrees and not higher than 35 degrees and an average foam cell diameter of not greater than 120 μm by the same production process as in the conventional case in which OBSH is used alone as the foaming agent for the electrically conductive rubber composition.

When the electrically conductive rubber composition is formed into a tubular body and then the tubular body is heated to foam and crosslink the rubber component for the production of the transfer roller, sodium hydrogen carbonate, which functions as an endothermic foaming agent and has a lower decomposition temperature than OBSH, first undergoes an endothermic reaction to suppress temperature rise of the rubber component immediately before decomposition of OBSH, thereby retarding the crosslinking of the rubber component.

Therefore, gas generated in excess by the subsequent decomposition of OBSH easily penetrates through rubber cell walls to the outside of the foam. This reduces the amount of gas incorporated in the individual foam cells. Therefore, the average foam cell diameter is controlled to not greater than 120 μm, which is smaller by at least 20 μm than in the case in which OBSH is used alone as the foaming agent without the use of sodium hydrogen carbonate.

The proportion of sodium hydrogen carbonate present in the electrically conductive rubber composition is limited to the range of not less than 0.25 parts by mass and not greater than 2.5 parts by mass based on 1 part by mass of OBSH for the following reason.

If the proportion of sodium hydrogen carbonate is less than the aforementioned range, it will be impossible to provide the effect of the combinational use of OBSH and sodium hydrogen carbonate for retarding the crosslinking of the rubber component to reduce the foam cell diameters, so that the average foam cell diameter will be greater than 120 μm.

If the proportion of sodium hydrogen carbonate is greater than the aforementioned range, on the other hand, the effect of sodium hydrogen carbonate for retarding the crosslinking of the rubber component will be excessively enhanced to inhibit the crosslinking of the rubber component. As a result, the transfer roller is liable to have a lower rubber hardness, i.e., an Asker-C hardness of lower than 25 degrees, and insufficient strength, thereby suffering from permanent compressive deformation.

Where the proportion of sodium hydrogen carbonate falls within the aforementioned range, in contrast, the inventive transfer roller can be produced, which is moderately flexible and substantially free from the permanent compressive deformation with an Asker-C hardness of not lower than 25 degrees and not higher than 35 degrees, and has a smooth outer peripheral surface with a reduced average foam cell diameter of not greater than 120 μm.

For further improvement of the effect, the proportion of sodium hydrogen carbonate is preferably not less than 0.3 parts by mass and not greater than 1.8 parts by mass based on 1 part by mass of OBSH within the aforementioned range.

The Asker-C hardness of the inventive transfer roller is limited to the range of not lower than 25 degrees and not higher than 35 degrees and the average foam cell diameter is limited to not greater than 120 μm for the aforementioned reason.

That is, if the Asker-C hardness is lower than 25 degrees, the transfer roller is liable to suffer from the permanent compressive deformation with insufficient strength. If the Asker-C hardness is higher than 35 degrees, it will be impossible to impart the transfer roller with proper flexibility.

If the average foam cell diameter is greater than 120 μm, the transfer roller will have a less smooth outer peripheral surface, thereby failing to satisfy the recent requirement for the higher-quality image formation of the image forming apparatus.

Where the Asker-C hardness and the average foam cell diameter respectively fall within the aforementioned ranges, the transfer roller can be provided which is moderately flexible and substantially free from the permanent compressive deformation and has a smaller average foam cell diameter to satisfy the requirement for the higher-quality image formation.

For further improvement of the effect, the average foam cell diameter is preferably smaller than 100 μm within the aforementioned range.

The lower limit of the average foam cell diameter is not particularly specified, but is preferably not smaller than 82 μm, particularly preferably not smaller than 84 μm. If the average foam cell diameter is smaller than this range, it will be impossible to impart the transfer roller with proper flexibility with an Asker-C hardness higher than the aforementioned range.

In Patent Document 2, it is stated that two types of foaming agents having decomposition temperatures different from each other by 10° C. or more are used, and a closed cell structure is first formed by performing a first-stage foaming step at a temperature at which only a lower decomposition temperature foaming agent is decomposed (i.e., at a temperature not lower than the decomposition temperature of the lower decomposition temperature foaming agent and lower than the decomposition temperature of a higher decomposition temperature foaming agent), and then the closed cell structure is destroyed to allow a multiplicity of foam cells to communicate with each other by performing a second-stage foaming step at a temperature at which the higher decomposition temperature foaming agent is decomposed (i.e., at a temperature not lower than the decomposition temperature of the higher decomposition temperature foaming agent), i.e., the hardness of the foam is reduced by a two-stage foaming process.

In Patent Document 2, it is also stated that examples of the foaming agent include OBSH and sodium hydrogen carbonate.

In the two-stage foaming process described in Patent Document 2, however, the multiplicity of foam cells formed in the first-stage foaming step are allowed to communicate with each other in the second-stage foaming step to increase the foam cell diameters, as apparent from the aforementioned mechanism. Even with the combinational use of OBSH and sodium hydrogen carbonate as the foaming agent, therefore, it will be impossible to produce a transfer roller having an Asker-C hardness of not lower than 25 degrees and not higher than 35 degrees and an average foam cell diameter of not greater than 120 μm as in the present invention.

In Example 1 of Patent Document 2, the average cell diameter is smaller (80 μm). This is because a mold is used in the first-stage foaming step to mechanically suppress the foaming. As apparent from the results for Conventional Example 2 to be described later, for example, where a foaming/crosslinking process is performed with the use of a vulcanization can or a continuous crosslinking apparatus by the method described in Patent Document 2, the average cell diameter will be greater than 120 μm due to the aforementioned mechanism. Therefore, the Asker-Chardness is liable to be lower than 25 degrees.

### <Rubber Component>

Various rubbers foamable by the action of the foaming agent and crosslinkable by the action of the crosslinking component are usable as the rubber component for the electrically conductive rubber composition.

In order to impart the electrically conductive rubber composition with proper electrical conductivity, an epichlorohydrin rubber having ion conductivity is particularly preferred.

### (Epichlorohydrin Rubber)

Various ion-conductive polymers each containing epichlorohydrin as a repeating unit are usable as the epichlorohydrin rubber.

Examples of the epichlorohydrin rubber include epichlorohydrin homopolymers, epichlorohydrin-ethylene oxide bipolymers (ECO), epichlorohydrin-propylene oxide bipolymers, epichlorohydrin-allyl glycidyl ether bipolymers, epichlorohydrin-ethylene oxide-allyl glycidyl ether terpolymers (GECO), epichlorohydrin-propylene oxide-allyl glycidyl ether terpolymers and epichlorohydrin-ethylene oxide-propylene oxide-allyl glycidyl ether quaterpolymers, which may be used alone or in combination.

Of these epichlorohydrin rubbers, the ethylene oxide-containing copolymers, particularly the ECO and/or the GECO are preferred.

These copolymers preferably each have an ethylene oxide content of not less than 30 mol % and not greater than 80 mol %, particularly preferably not less than 50 mol %.

Ethylene oxide functions to reduce the roller resistance of the transfer roller. If the ethylene oxide content is less than the aforementioned range, however, it will be impossible to sufficiently provide this function and hence to sufficiently reduce the roller resistance.

If the ethylene oxide content is greater than the aforementioned range, on the other hand, ethylene oxide is liable to be crystallized, whereby the segment motion of molecular chains is hindered to adversely increase the roller resistance. Further, the transfer roller is liable to have an excessively high hardness after the crosslinking, and the electrically conductive rubber composition is liable to have a higher viscosity and, hence, poorer processability when being heat-melted before the crosslinking.

The ECO has an epichlorohydrin content that is a balance obtained by subtracting the ethylene oxide content from the total. That is, the epichlorohydrin content is preferably not less than 20 mol % and not greater than 70 mol %, particularly preferably not greater than 50 mol %.

The GECO preferably has an allyl glycidyl ether content of not less than 0.5 mol % and not greater than 10 mol %, particularly preferably not less than 2 mol % and not greater than 5 mol %.

Allyl glycidyl ether per se functions as side chains of the copolymer to provide a free volume, whereby the crystallization of ethylene oxide is suppressed to reduce the roller resistance of the transfer roller. However, if the allyl glycidyl ether content is less than the aforementioned range, it will be impossible to provide this function and, hence, to sufficiently reduce the roller resistance.

Allyl glycidyl ether also functions as crosslinking sites during the crosslinking of the GECO. Therefore, if the allyl glycidyl ether content is greater than the aforementioned range, the crosslinking density of the GECO is excessively increased, whereby the segment motion of molecular chains is hindered to adversely increase the roller resistance.

The GECO has an epichlorohydrin content that is a balance obtained by subtracting the ethylene oxide content and the allyl glycidyl ether content from the total. That is, the epichlorohydrin content is preferably not less than 10 mol % and not greater than 69.5 mol %, particularly preferably not less than 15 mol % and not greater than 48 mol %.

Examples of the GECO include copolymers of the three comonomers described above in a narrow sense, as well as known modification products obtained by modifying an epichlorohydrin-ethylene oxide copolymer (ECO) with allyl glycidyl ether. Any of these modification products may be used as the GECO.

Where the epichlorohydrin rubber is used in combination with an additional rubber to be described below as the rubber component, the proportion of the epichlorohydrin rubber is preferably not less than 20 parts by mass and not greater than 40 parts by mass based on 100 parts by mass of the overall rubber component.

If the proportion of the epichlorohydrin rubber is less than the aforementioned range, it will be impossible to impart the transfer roller with proper ion conductivity.

If the proportion of the epichlorohydrin rubber is greater than the aforementioned range, on the other hand, the proportion of the additional rubber is relatively reduced, making it impossible to sufficiently provide the effect of the combinational use of the rubbers to be described below.

### (Additional Rubber)

The additional rubber may be used in combination with the epichlorohydrin rubber as the rubber component.

Examples of the additional rubber include styrene butadiene rubber (SBR), ethylene propylene diene rubber (EPDM), acrylonitrile butadiene rubber (NBR), chloroprene rubber (CR), butadiene rubber (BR) and acryl rubber (ACM), at least one of which may be selected.

Particularly, the EPDM and the NBR are preferably used in combination.

The EPDM functions to improve the ozone resistance, the anti-aging property, the weather resistance and the like of the transfer roller.

Usable as the EPDM are various EPDMs each prepared by introducing double bonds into a main chain thereof by employing a small amount of a third ingredient (diene) in addition to ethylene and propylene. A variety of EPDM products containing different types of third ingredients in different amounts are commercially available. Typical examples of the third ingredients include ethylidene norbornene (ENB), 1,4-hexadiene (1,4-HD) and dicyclopentadiene (DCP). A Ziegler catalyst is typically used as a polymerization catalyst.

The EPDMs include those of an oil-extension type having flexibility controlled by addition of an extension oil, and those of a non-oil-extension type containing no extension oil. Either type of EPDMs is usable.

These EPDMs may be used alone or in combination.

The NBR functions to improve the mechanical strength, the durability and the like of the transfer roller, and to impart the transfer roller with rubber characteristic properties, i.e., to make the transfer roller flexible and less susceptible to the permanent compressive deformation with a reduced compression set.

The NBR is classified in a lower acrylonitrile content type, an intermediate acrylonitrile content type, an intermediate to higher acrylonitrile content type, a higher acrylonitrile content type or a very high acrylonitrile content type depending on the acrylonitrile content. Any of these types of NBRs is usable.

The NBRs include those of an oil-extension type having flexibility controlled by addition of an extension oil, and those of a non-oil-extension type containing no extension oil. Either type of NBRs is usable.

These NBRs may be used alone or in combination.

The proportion of the EPDM to be blended is preferably not less than 5 parts by mass and not greater than 20 parts by mass based on 100 parts by mass of the overall rubber component.

If the proportion of the EPDM is less than the aforementioned range, it will be impossible to impart the transfer roller with proper ozone resistance.

If the proportion of the EPDM is greater than the aforementioned range, on the other hand, the proportion of the epichlorohydrin rubber is relatively reduced, making it impossible to impart the transfer roller with proper ion conductivity. Further, the proportion of the NBR is reduced, making it impossible to improve the mechanical strength and the like of the transfer roller and to impart the transfer roller with proper rubber characteristic properties.

The proportion of the NBR to be blended is a balance obtained by subtracting the amounts of the epichlorohydrin rubber and the EPDM from the total. That is, the proportion of the NBR may be determined so that the total amount of the epichlorohydrin rubber, the EPDM and the NBR for the rubber component is 100 parts by mass when the proportions of the epichlorohydrin rubber and the EPDM are predetermined.

Where the oil-extension type EPDM and/or NBR is used, the proportion of the EPDM and/or NBR is defined as the solid proportion of the EPDM and/or NBR contained in the oil-extension type EPDM and/or NBR.

### <Crosslinking Component>

The crosslinking component for crosslinking the rubber component includes a crosslinking agent, a crosslinking assisting agent and the like. Particularly, a sulfur-containing crosslinking agent is preferred as the crosslinking agent.

Examples of the sulfur-containing crosslinking agent include sulfur such as sulfur powder, oil-treated sulfur powder, precipitated sulfur, colloidal sulfur and dispersive sulfur, and organic sulfur-containing compounds such as tetramethylthiuram disulfide and N,N-dithiobismorpholine. Particularly, the sulfur is preferred.

The proportion of the sulfur to be blended is preferably not less than 0.5 parts by mass and not greater than 3 parts by mass based on 100 parts by mass of the overall rubber component.

Where the oil-treated sulfur powder or the dispersive sulfur is used, for example, the proportion of the sulfur is defined as the effective proportion of sulfur contained in the oil-treated sulfur powder or the dispersive sulfur.

Examples of the crosslinking accelerating agent include a thiuram accelerating agent and a thiazole accelerating agent. Different types of crosslinking accelerating agents have different crosslinking accelerating mechanisms and, therefore, are preferably used in combination.

Examples of the thiuram accelerating agent include tetramethylthiuram monosulfide (TS), tetramethylthiuram disulfide (TT, TMT), tetraethylthiuram disulfide (TET), tetrabutylthiuram disulfide (TBT), tetrakis(2-ethylhexyl)thiuram disulfide (TOT-N) and dipentamethylenethiuram tetrasulfide (TRA), which may be used alone or in combination.

The proportion of the thiuram accelerating agent to be blended is preferably not less than 0.5 parts by mass and not greater than 3 parts by mass based on 100 parts by mass of the overall rubber component.

Examples of the thiazole accelerating agent include 2-mercaptobenzothiazole (M), di-2-benzothiazolyl disulfide (DM), a zinc salt of 2-mercaptobenzothiazole (MZ), a cyclohexylamine salt of 2-mercaptobenzothiazole (HM, M60-OT), 2-(N,N-diethylthiocarbamoylthio)benzothiazole (64) and 2-(4′-morpholinodithio)benzothiazole (DS, MDB), which may be used alone or in combination.

The proportion of the thiazole accelerating agent is preferably not less than 0.5 parts by mass and not greater than 3 parts by mass based on 100 parts by mass of the overall rubber component.

### <Foaming Agent>

As described above, OBSH is used as the foaming agent. Specific examples of OBSH include NEOCELLBON (registered trade name) N#1000SW, N#1000S, N#5000, N#1000M, N#5000# and SB#51 available from Eiwa Chemical Industry Co., Ltd., which may be used alone or in combination.

The proportion of OBSH to be blended is preferably not less than 2 parts by mass and not greater than 6 parts by mass, particularly preferably not less than 3 parts by mass and not greater than 5 parts by mass, based on 100 parts by mass of the overall rubber component.

If the proportion of OBSH is less than the aforementioned range, it will be impossible to sufficiently foam the rubber component. Therefore, the Asker-C hardness of the transfer roller is liable to be greater than the aforementioned range, making it impossible to impart the transfer roller with proper flexibility.

If the proportion of OBSH is greater than the aforementioned range, expansion of foam cells will be suppressed by expansion forces of simultaneously expanded adjacent foam cells to excessively reduce the average foam cell diameter. Therefore, the Asker-C hardness of the transfer roller is liable to be greater than the aforementioned range, making it impossible to impart the transfer roller with proper flexibility.

Where the proportion of OBSH falls within the aforementioned range, in contrast, the transfer roller can be produced as having proper flexibility with an Asker-C hardness thereof falling within the aforementioned range.

Not by way of limitation, specific examples of sodium hydrogen carbonate to be used in combination with OBSH include CELLBON (trade name) FE-507, FE-507R, SC-P, SC-K and FE-512 available from Eiwa Chemical Industry Co., Ltd., which may be used alone or in combination.

Particularly, FE-507 and SC-K are preferred, which may be used alone, or used in combination to be blended in proper proportions.

The proportion of sodium hydrogen carbonate to be blended should be not less than 0.25 parts by mass and not greater than 2.5 parts by mass based on 1 part by mass of OBSH for the aforementioned reason.

### <Other Ingredients>

As required, various additives may be added to the rubber composition. Examples of the additives include a crosslinking acceleration assisting agent, an acid accepting agent and a filler.

Examples of the crosslinking acceleration assisting agent include: metal compounds such as zinc oxide (zinc white); fatty acids such as stearic acid, oleic acid and cotton seed fatty acids; and other conventionally known crosslinking acceleration assisting agents, which may be used alone or in combination.

The proportions of the crosslinking acceleration assisting agents to be added are each preferably not less than 0.1 part by mass and not greater than 7 parts by mass based on 100 parts by mass of the overall rubber component.

In the presence of the acid accepting agent, chlorine-containing gases generated from the epichlorohydrin rubber and the like during the crosslinking are prevented from remaining in the transfer roller. Thus, the acid accepting agent functions to prevent the inhibition of the crosslinking and the contamination of the photoreceptor body, which may otherwise be caused by the chlorine-containing gases.

Any of various substances serving as acid acceptors may be used as the acid accepting agent. Preferred examples of the acid accepting agent include hydrotalcites and Magsarat which are excellent in dispersibility. Particularly, the hydrotalcites are preferred.

Where the hydrotalcites are used in combination with magnesium oxide or potassium oxide, a higher acid accepting effect can be provided, thereby more reliably preventing the contamination of the photoreceptor body.

The proportion of the acid accepting agent to be added is preferably not less than 0.2 parts by mass and not greater than 5 parts by mass, particularly preferably not less than 0.5 parts by mass and not greater than 2 parts by mass, based on 100 parts by mass of the overall rubber component.

If the proportion of the acid accepting agent is less than the aforementioned range, it will be impossible to sufficiently provide the effect of the addition of the acid accepting agent. If the proportion of the acid accepting agent is greater than the aforementioned range, the transfer roller is liable to have a higher hardness after the crosslinking.

Examples of the filler include zinc oxide, silica, carbon black, clay, talc, calcium carbonate, magnesium carbonate and aluminum hydroxide, which may be used alone or in combination.

The addition of the filler improves the mechanical strength and the like of the transfer roller.

Where electrically conductive carbon black is used as the filler, it is possible to impart the transfer roller with electron conductivity, and to improve the microwave absorption efficiency of the entire electrically conductive rubber composition when the transfer roller is produced by passing a tubular body of the rubber composition continuously through a continuous crosslinking apparatus including a microwave crosslinking device and a hot air crosslinking device to be described layer.

HAF (High Abrasion Furnace) black is preferably used as the electrically conductive carbon black. The HAF black is excellent in microwave absorption efficiency, and is homogenously dispersible in the electrically conductive rubber composition, making it possible to impart the transfer roller with more uniform electron conductivity.

The proportion of the electrically conductive carbon black is preferably not less than 5 parts by mass and not greater than 20 parts by mass based on 100 parts by mass of the overall rubber component.

Other examples of the additives include a degradation preventing agent, an anti-scorching agent, a plasticizer, a lubricant, a pigment, an anti-static agent, a flame retarder, a neutralizing agent, a nucleating agent and a co-crosslinking agent, which may be added in proper proportions to the rubber composition.

### <<Transfer Roller>>

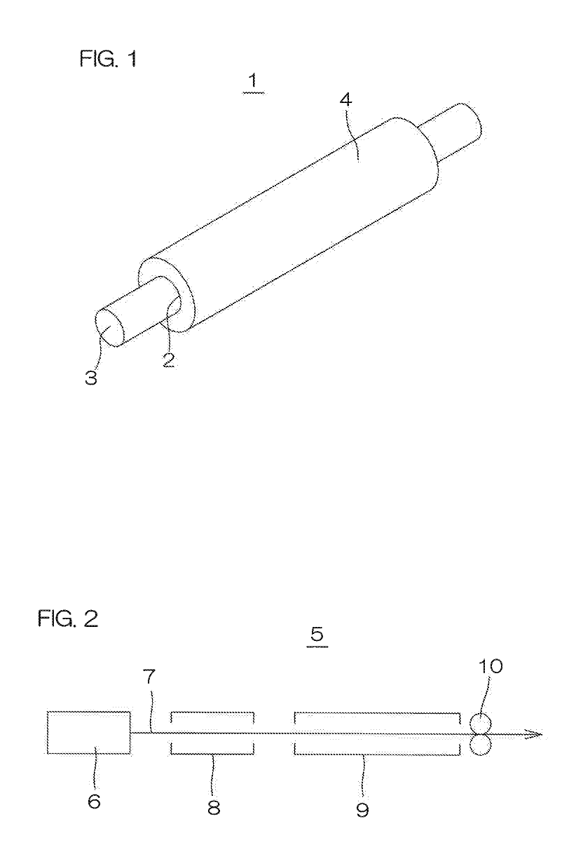

FIG. 1 is a perspective view illustrating an exemplary transfer roller according to one embodiment of the present invention.

Referring to FIG. 1, the transfer roller 1 according to this embodiment is a tubular rubber foam of a single-layer structure formed from the electrically conductive rubber composition containing the ingredients described above, and a shaft 3 is inserted through and fixed to a center through-hole 2 of the transfer roller 1.

The shaft 3 is a unitary member made of a metal such as aluminum, an aluminum alloy or a stainless steel.

The shaft 3 is electrically connected to and mechanically fixed to the transfer roller 1, for example, via an electrically conductive adhesive agent. Alternatively, a shaft having an outer diameter that is greater than the inner diameter of the through-hole 2 is used as the shaft 3, and press-inserted into the through-hole 2 to be electrically connected to and mechanically fixed to the transfer roller 1. Thus, the shaft 3 and the transfer roller 1 are unitarily rotatable.

The transfer roller 1 should have an Asker-C hardness of not lower than 25 degrees and not higher than 35 degrees, and an average foam cell diameter of not greater than 120 μm. The average cell diameter is preferably not smaller than 82 μm, particularly preferably not smaller than 84 μm for the aforementioned reason.

The Asker-C hardness of the transfer roller 1 is measured by the following method by means of a type-C hardness tester (e.g., an Asker rubber hardness meter type-C available from Kobunshi Keiki Co., Ltd. or the like) which conforms to the Society of Rubber Industry Standards SRIS0101 “Physical Test Methods for Expanded Rubber” employed in Appendix 2 of the Japanese Industrial Standards JIS K7312_{—1996} “Physical testing methods for molded products of thermosetting polyurethane elastomers.”

More specifically, opposite end portions of the shaft 3 unified with the transfer roller 1 as described above are fixed to a support base and, in this state, an indenter point of the aforementioned Type-C hardness tester is pressed against a middle portion of the transfer roller 1, and the Asker-C hardness of the transfer roller 1 is measured with application of a load of 10 N (≈1 kgf).

The average foam cell diameter is determined by observing an outer peripheral surface 4 of the transfer roller 1 at a magnification of 200× by means of a microscope, measuring the major diameters (μm) and the minor diameters (μm) of 30 largest foam cells in the field of view of the microscope, calculating the cell diameter of each of the foam cells from the following expression (1), and averaging the cell diameters of the foam cells.

Cell diameter (μm)=(Major diameter+Minor diameter)/2 (1)

The tests described above are performed at a temperature of 23° C. at a relative humidity of 55%.

The inventive transfer roller 1 can be incorporated in an electrophotographic image forming apparatus such as a laser printer, an electrostatic copying machine, a plain paper facsimile machine or a printer-copier-facsimile multifunction machine for transferring a toner image from a surface of a photoreceptor body onto a surface of a sheet or a surface of an image carrier.

### <<Transfer Roller Production Method I>>

In an inventive production method for producing the transfer roller 1, the electrically conductive rubber composition containing the ingredients described above is extruded into a tubular body by means of an extruder, and the tubular body is cut to a predetermined length and maintained at a temperature of not lower than 120° C. and not higher than 140° C. in a vulcanization can to foam the rubber composition by a single-stage foaming process.

The foaming temperature is set within the aforementioned range for the following reason.

If the foaming temperature is lower than the aforementioned range, the foaming will be insufficient. Therefore, the transfer roller 1 is liable to have an average cell diameter of smaller than 82 μm and an Asker-C hardness of higher than 35 degrees. Thus, it will be impossible to impart the transfer roller 1 with proper flexibility.

If the foaming temperature is higher than the aforementioned range, on the other hand, the foaming will be excessive. Therefore, the transfer roller 1 is liable to have a less smooth outer peripheral surface with an average cell diameter of greater than 120 μm, thereby failing to satisfy the recent requirement for the higher-quality image formation of the image forming apparatus.

After the foaming, the inside of the vulcanization can may be heated to the aforementioned foaming temperature or higher, particularly 150° C. or higher, and maintained at that temperature for 25 minutes or shorter period of time to complete the crosslinking of the rubber component, which already proceeds in the foaming process.

However, the vulcanization can should not be maintained at the higher temperature for longer than the aforementioned period. If the heating at the higher temperature is continued for a longer period, the average foam cell diameter is liable to exceed 120 μm due to the second-stage foaming step described in Patent Document 2.

In the present invention, the period of the heating at the higher temperature for the completion of the crosslinking is preferably as short as possible within the aforementioned range, and the heating may be obviated in some case.

Subsequently, the tubular body thus foamed and crosslinked is heated in an oven or the like to be thereby secondarily crosslinked. Then, the resulting tubular body is cooled, and polished to a predetermined outer diameter.

The shaft 3 is inserted through and fixed to the through-hole 2 at any time between the end of the cutting of the tubular body and the end of the polishing.

However, the tubular body is preferably secondarily crosslinked and polished with the shaft 3 inserted through the through-hole 2 after the cutting. This suppresses the warpage and the deformation of the tubular body, which may otherwise occur due to the expansion and the contraction of the tubular body during the secondary crosslinking. Further, the tubular body may be polished while being rotated about the shaft 3. This improves the working efficiency in the polishing, and suppresses the deflection of the outer peripheral surface 4 of the transfer roller 1.

As previously described, the shaft 3 may be inserted through the through-hole 2 of the tubular body yet to be subjected to the secondary crosslinking with the intervention of the electrically conductive adhesive agent (particularly, a thermosetting adhesive agent), and then the tubular body is secondarily crosslinked. Alternatively, the shaft 3 having an outer diameter that is greater than the inner diameter of the through-hole 2 may be press-inserted through the through-hole 2.

In the former case, the thermosetting adhesive agent is cured when the tubular body is secondarily crosslinked by the heating in the oven. Thus, the shaft 3 is electrically connected to and mechanically fixed to the transfer roller 1. In the latter case, the electrical connection and the mechanical fixing are achieved simultaneously with the press insertion.

In the inventive production method, the tubular body formed by the extrusion is maintained at a temperature of not lower than 120° C. and not higher than 140° C. to be thereby foamed by the single-stage foaming process, whereby the inventive transfer roller can be produced as having an Asker-C hardness of not lower than 25 degrees and not higher than 35 degrees and an average foam cell diameter of not greater than 120 μm.

### <<Transfer Roller Production Method II>>

In another inventive production method for producing the transfer roller 1, a continuous crosslinking apparatus including a microwave crosslinking device and a hot air crosslinking device is employed.

FIG. 2 is a block diagram for briefly explaining the continuous crosslinking apparatus by way of example.

Referring to FIGS. 1 and 2, the exemplary continuous crosslinking apparatus 5 includes a microwave crosslinking device 8, a hot air crosslinking device 9 and a take-up device 10 provided in this order on a continuous transportation path along which an elongated tubular body 7 formed by continuously extruding the electrically conductive rubber composition by an extruder 6 for the transfer roller 1 is continuously transported in the elongated state without cutting by a conveyor (not shown) or the like. The take-up device 10 is adapted to take up the tubular body 7 at a predetermined speed.

In the production method employing the continuous crosslinking apparatus 5, the ingredients described above are first kneaded together. The resulting electrically conductive rubber composition is formed into a ribbon shape, and continuously fed into the extruder 6 to be continuously extruded into the elongated tubular body 7 by operating the extruder 6.

In turn, the tubular body 7 formed by the extrusion is continuously transported at the predetermined speed by the conveyor and the take-up device 10 to be passed through the microwave crosslinking device 8 of the continuous crosslinking apparatus 5, whereby the rubber component of the tubular body 7 is crosslinked to a certain crosslinking degree by irradiation with microwaves.

Subsequently, the tubular body 7 is further transported to be passed through the hot air crosslinking device 9, whereby hot air at a temperature of not lower than 120° C. and not higher than 140° C. is applied to the tubular body 7. Thus, the rubber component is foamed and crosslinked to a predetermined crosslinking degree.

Thereafter, the tubular body 7 is cooled. Thus, the single-stage foaming and the crosslinking of the tubular body 7 in the aforementioned temperature range are completed.

The inside of the microwave crosslinking device 8 may be heated to a temperature of not lower than 120° C. and not higher than 140° C. to crosslink and foam the rubber component.

Even in this case, the continuous foaming of the tubular body 7 in the devices 8, 9 may be regarded as the single-stage foaming process.

The tubular body 7, which has a rubber foaming state and a rubber crosslinking density each controlled at a predetermined level, can be continuously produced with improved productivity by properly setting the transportation speed of the tubular body 7, the microwave irradiation dose of the microwave crosslinking device 8, the setting temperature and the length of the hot air crosslinking device 9, and the like (the microwave crosslinking device 8 and the hot air crosslinking device 9 may be each divided into a plurality of sections, and the setting temperature may be changed stepwise within the temperature range of not lower than 120° C. and not higher than 140° C. for these sections).

The tubular body 7 being transported may be twisted so that the microwave irradiation dose and the heating degree can be made more uniform throughout the tubular body 7 to make the foaming state and the crosslinking density as uniform as possible.

Thereafter, the tubular body 7 thus foamed and crosslinked is cut to a predetermined length, and subjected to the same process as in the production method I, whereby the inventive transfer roller 1 is produced.

More specifically, the tubular body 7 cut to the predetermined length is heated in an over or the like to be secondarily crosslinked. Then, the resulting tubular body 7 is cooled, and polished to a predetermined outer diameter.

The shaft 3 may be inserted into and fixed to the through-hole 2 at any time between the end of the cutting of the tubular body and the end of the polishing of the tubular body.

However, the tubular body is preferably secondarily crosslinked and polished with the shaft 3 inserted through the through-hole 2 after the cutting. This suppresses the warpage and the deformation of the tubular body, which may otherwise occur due to the expansion and the contraction of the tubular body during the secondary crosslinking. Further, the tubular body may be polished while being rotated about the shaft 3. This improves the working efficiency in the polishing, and suppresses the deflection of the outer peripheral surface 4 of the transfer roller 1.

As previously described, the shaft 3 may be inserted through the through-hole 2 of the tubular body yet to be subjected to the secondary crosslinking with the intervention of the electrically conductive adhesive agent (particularly, a thermosetting adhesive agent), and then the tubular body is secondarily crosslinked. Alternatively, the shaft 3 having an outer diameter that is greater than the inner diameter of the through-hole 2 may be press-inserted through the through-hole 2.

In the former case, the thermosetting adhesive agent is cured when the tubular body is secondarily crosslinked by the heating in the oven. Thus, the shaft 3 is electrically connected to and mechanically fixed to the transfer roller 1. In the latter case, the electrical connection and the mechanical fixing are achieved simultaneously with the press insertion.

In the inventive production method, the tubular body formed by the extrusion is continuously passed through the continuous crosslinking apparatus 5 including the microwave crosslinking device 8 and the hot air crosslinking device 9 to be maintained at a temperature of not lower than 120° C. and not higher than 140° C. Thus, the tubular body is foamed by the single-stage foaming process, whereby the inventive transfer roller can be produced as having an Asker-C hardness of not lower than 25 degrees and not higher than 35 degrees and an average foam cell diameter of not greater than 120 μm.

### EXAMPLES

### Example 1

### (Preparation of Rubber Composition)

A rubber component was prepared by blending 30 parts by mass of GECO (HYDRIN (registered trade name) T3108 available from Zeon Corporation), 10 parts by mass of EPDM (non-oil-extension type, ESPRENE (registered trade name) 505A available from Sumitomo Chemical Co., Ltd.) and 60 parts by mass of NBR (non-oil-extension type, Nipol (registered trade name) DN401LL available from Zeon Corporation, and having a bonded acrylonitrile content of 18.0% (median)).

While 100 parts by mass of the rubber component including the aforementioned rubbers was simply kneaded by means of a Banbury mixer, carbon black and hydrotalcites out of ingredients shown below in Table 1 were added to and kneaded with the rubber component. Then, the other ingredients were further added to and kneaded with the resulting mixture. Thus, an electrically conductive rubber composition was prepared.

TABLE 1

| Ingredients | Parts by mass |
|---|---|
| Foaming agent OBSH | 4 |
| Sodium hydrogen carbonate | 1.5 |
| Carbon black | 10 |
| Hydrotalcites | 1.5 |
| Sulfur powder | 1.6 |
| Crosslinking accelerating agent DM | 1.6 |
| Crosslinking accelerating agent TS | 2 |

The ingredients shown in Table 1 are as follows. The amounts (parts by mass) of the ingredients shown in Table 1 are based on 100 parts by mass of the overall rubber component.

Foaming agent OBSH: NEOCELLBON (registered trade name) N#1000SW available from Eiwa Chemical Industry Co., Ltd. Sodium hydrogen carbonate: A mixture containing CELLBON FE-507 and CELLBON SC-K (trade name) available from Eiwa Chemical Industry Co., Ltd. in a mass ratio of FE-507:SC-K=1:2

Carbon black: HAF SEAST 3 (trade name) available from Tokai Carbon Co., Ltd.
Hydrotalcites: Acid accepting agent DHT-4A-2 available from Kyowa Chemical Industry Co., Ltd.
Sulfur powder: Crosslinking agent available from Tsurumi Chemical Industry Co., Ltd.
Crosslinking accelerating agent DM: Di-2-benzothiazyl disulfide SUNSINE METS (trade name) available from Shandong Shanxian Chemical Co., Ltd.
Crosslinking accelerating agent TS: Tetramethylthiuram disulfide SANCELER (registered trade name) TS available from Sanshin Chemical Industry Co., Ltd.

The blending proportion of sodium hydrogen carbonate based on 1 part by mass of OBSH was 0.375 parts by mass.

### (Production of Transfer Roller)

The electrically conductive rubber composition thus prepared was fed into an extruder, and extruded into a tubular body having an outer diameter of 10 mm and an inner diameter of 3.0 mm. Then, the tubular body was cut to a predetermined length, and fitted around a temporary crosslinking shaft having an outer diameter of 2.2 mm.

Then, the tubular body was pressurized and heated at 135° C. for 10 minutes in a vulcanization can by pressurized steam, whereby the tubular body was foamed by gas generated by decomposition of the foaming agent and the rubber component was crosslinked.

Then, the tubular body was removed from the temporary shaft, and then fitted around a shaft 3 having an outer diameter of 5 mm and an outer peripheral surface to which an electrically conductive thermosetting adhesive agent was applied. The tubular body was heated in an oven at 160° C. for 60 minutes, whereby the rubber component of the tubular body was secondarily crosslinked and the thermosetting adhesive agent was cured. Thus, the tubular body was electrically connected to and mechanically fixed to the shaft 3.

In turn, opposite end portions of the tubular body were cut, and the outer peripheral surface 4 of the resulting tubular body was traverse-polished to an outer diameter of 12.5 mm (with a tolerance of ±0.1 mm) by means of a cylindrical polishing machine. Thus, a transfer roller 1 was produced.

### Example 2

An electrically conductive rubber composition was prepared and a transfer roller 1 was produced in substantially the same manner as in Example 1, except that the proportion of sodium hydrogen carbonate was 4 parts by mass based on 100 parts by mass of the overall rubber component. The blending proportion of sodium hydrogen carbonate based on 1 part by mass of OBSH was 1 part by mass.

### Example 3

An electrically conductive rubber composition was prepared and a transfer roller 1 was produced in substantially the same manner as in Example 1, except that the proportion of sodium hydrogen carbonate was 9.5 parts by mass based on 100 parts by mass of the overall rubber component. The blending proportion of sodium hydrogen carbonate based on 1 part by mass of OBSH was 2.375 parts by mass.

### Comparative Example 1

An electrically conductive rubber composition was prepared and a transfer roller 1 was produced in substantially the same manner as in Example 1, except that the proportion of sodium hydrogen carbonate was 0.5 parts by mass based on 100 parts by mass of the overall rubber component. The blending proportion of sodium hydrogen carbonate based on 1 part by mass of OBSH was 0.125 parts by mass.

### Comparative Example 2

An electrically conductive rubber composition was prepared and a transfer roller 1 was produced in substantially the same manner as in Example 1, except that the proportion of sodium hydrogen carbonate was 10.5 parts by mass based on 100 parts by mass of the overall rubber component. The blending proportion of sodium hydrogen carbonate based on 1 part by mass of OBSH was 2.625 parts by mass.

### Conventional Example 1

An electrically conductive rubber composition was prepared and a transfer roller 1 was produced in substantially the same manner as in Example 1, except that sodium hydrogen carbonate was not blended.

### Conventional Example 2

A transfer roller 1 was produced in substantially the same manner as in Example 1, except that the tubular body formed in Example 1 was pressurized and heated at 135° C. for 10 minutes in a vulcanization can by pressurized steam in a first-stage foaming step and then pressurized and heated at 165° C. for 3 hours in the vulcanization can by pressurized steam in a second-stage foaming step.

Conventional Example 2 corresponds to the roller produced by the method described in Patent Document 2 by using OBSH and sodium hydrogen carbonate in combination as the foaming agent, and foaming and crosslinking the tubular body in the vulcanization can without the use of a mold in the first-stage crosslinking step.

### <Measurement of Asker-C Hardness and Evaluation>

The Asker-C hardness of each of the transfer rollers 1 produced in Examples 1 to 3, Comparative Examples 1 and 2 and Conventional Examples 1 and 2 was measured by the aforementioned measurement method. A transfer roller having an Asker-C hardness of not lower than 25 degrees and not higher than 35 degrees was rated as acceptable (∘), and a transfer roller having an Asker-C hardness of lower than 25 degrees or higher than 35 degrees was rated as unacceptable (x).

### <Measurement of Average Cell Diameter and Evaluation>

The average cell diameter of each of the transfer rollers 1 produced in Examples 1 to 3, Comparative Examples 1 and 2 and Conventional Examples 1 and 2 was measured by the aforementioned measurement method. A transfer roller having an average cell diameter of not greater than 120 μm was rated as acceptable (∘), and a transfer roller having an average cell diameter of greater than 120 μm was rated as unacceptable (x).

The above results are shown in Tables 2 and 3.

TABLE 2

| Crosslinking in | Conventional | Comparative | Example | Example |
|---|---|---|---|---|
| vulcanization can | Example 1 | Example 1 | 1 | 2 |

Parts by mass

| | | | | |
|---|---|---|---|---|
| OBSH | 4 | 4 | 4 | 4 |

Sodium hydrogen carbonate

| | | | | |
|---|---|---|---|---|
| Based on rubber | — | 0.5 | 1.5 | 4 |
| component | | | | |
| Based on OBSH | — | 0.125 | 0.375 | 1 |
| Foaming | 135 | 135 | 135 | 135 |
| temperature (° C.) | | | | |

Test

Asker-C hardness

| | | | | |
|---|---|---|---|---|
| Value (degree) | 27 | 28 | 30 | 29 |
| Evaluation | ∘ | ∘ | ∘ | ∘ |

Average cell diameter

| | | | | |
|---|---|---|---|---|
| Value (μm) | 144 | 140 | 115 | 98 |
| Evaluation | x | x | ∘ | ∘ |

TABLE 3

| Crosslinking in | Example | Comparative | Conventional |
|---|---|---|---|
| vulcanization can | 3 | Example 2 | Example 2 |

Parts by mass

| | | | |
|---|---|---|---|
| OBSH | 4 | 4 | 4 |

Sodium hydrogen carbonate

| | | | |
|---|---|---|---|
| Based on rubber component | 9.5 | 10.5 | 1.5 |
| Based on OBSH | 2.375 | 2.625 | 0.375 |
| Foaming temperature (° C.) | 135 | 135 | 135 → 165 |

Test

Asker-C hardness

| | | | |
|---|---|---|---|
| Value (degree) | 26 | 24 | 24 |
| Evaluation | ∘ | x | x |

Average cell diameter

| | | | |
|---|---|---|---|
| Value (μm) | 84 | 80 | 152 |
| Evaluation | ∘ | ∘ | x |

The results for Conventional Example 2 shown in Table 3 indicate that, even if OBSH and sodium hydrogen carbonate are used in combination as the foaming agent, it is impossible to produce a transfer roller having an Asker-C hardness of not lower than 25 degrees and not higher than 35 degrees and an average foam cell diameter of not greater than 120 μm by the method described in Patent Document 2.

The results for Examples 1 to 3 and Conventional Example 1 shown in Tables 2 and 3 indicate that, where OBSH and sodium hydrogen carbonate are used in combination as the foaming agent and the tubular body is foamed at a heating temperature of not lower than 120° C. and not higher than 140° C. by the single-stage foaming process, it is possible to produce a transfer roller which is flexible and has an Asker-C hardness and an average cell diameter respectively falling within the aforementioned ranges, a lower rubber hardness and a smooth outer peripheral surface.

However, the results for Examples 1 to 3 and Comparative Examples 1 and 2 indicate that, in order to provide the aforementioned effect, the blending proportion of sodium hydrogen carbonate should be not less than 0.25 parts by mass and not greater than 2.5 parts by mass based on 1 part by mass of OBSH.

### Example 4

The electrically conductive rubber composition prepared in Example 1 was formed into a ribbon shape, and continuously fed into an extruder 6 to be extruded into an elongated tubular body 7 having an outer diameter of 10 mm and an inner diameter of 3.0 mm. The tubular body 7 formed by the extrusion was continuously fed out in an elongated state without cutting to be continuously passed through the continuous crosslinking apparatus 5 including the microwave crosslinking device 8 and the hot air crosslinking device 9, whereby the rubber component of the tubular body was continuously foamed and crosslinked. Then, the resulting tubular body was passed through cooling water to be continuously cooled.

The microwave crosslinking device 8 had an output of 6 to 12 kW and an internal control temperature of 135° C. The hot air crosslinking device 9 had an internal control temperature of 135° C. and an effective heating chamber length of 8 m.

In turn, the tubular body was cut to a predetermined length. The resulting tubular body was fitted around a shaft 3 having an outer diameter of 5 mm and an outer peripheral surface to which an electrically conductive thermosetting adhesive agent was applied, and heated at 160° C. for 60 minutes in an oven, whereby the rubber component of the tubular body was secondarily crosslinked and the thermosetting adhesive agent was cured. Thus, the tubular body was electrically connected to and mechanically fixed to the shaft 3.

After opposite end portions of the tubular body 7 were cut, the outer peripheral surface 4 of the tubular body 7 was traverse-polished to an outer diameter of 12.5 mm (with a tolerance of ±0.1 mm) by means of a cylindrical polishing machine. Thus, a transfer roller 1 was produced.

### Example 5

A transfer roller 1 was produced in substantially the same manner as in Example 4, except that the electrically conductive rubber composition prepared in Example 2 was used.

### Example 6

A transfer roller 1 was produced in substantially the same manner as in Example 4, except that the electrically conductive rubber composition prepared in Example 3 was used.

### Comparative Example 3

A transfer roller 1 was produced in substantially the same manner as in Example 4, except that the electrically conductive rubber composition prepared in Comparative Example 1 was used.

### Comparative Example 4

A transfer roller 1 was produced in substantially the same manner as in Example 4, except that the electrically conductive rubber composition prepared in Comparative Example 2 was used.

### Conventional Example 3

A transfer roller 1 was produced in substantially the same manner as in Example 4, except that the electrically conductive rubber composition prepared in Conventional Example 1 was used.

The Asker-C hardness and the average cell diameter of each of the transfer rollers produced in Examples 4 to 6, Comparative Examples 3 and 4 and Conventional Example 3 were measured, and the transfer rollers were evaluated for the Asker-C hardness and the average cell diameter. The results are shown in Table 4.

TABLE 4

| | Conventional | Comparative | Example | Example | Example | Comparative |
|---|---|---|---|---|---|---|
| Continuous crosslinking | Example 3 | Example 3 | 4 | 5 | 6 | Example 4 |

Parts by mass

| | | | | | | |
|---|---|---|---|---|---|---|
| OBSH | 4 | 4 | 4 | 4 | 4 | 4 |

Sodium hydrogen carbonate

| | | | | | | |
|---|---|---|---|---|---|---|
| Based on rubber component | — | 0.5 | 1.5 | 4 | 9.5 | 10.5 |
| Based on OBSH | — | 0.125 | 0.375 | 1 | 2.375 | 2.625 |
| Foaming temperature (° C.) | 135 | 135 | 135 | 135 | 135 | 135 |

Test
Asker-C hardness

| | | | | | | |
|---|---|---|---|---|---|---|
| Value (degree) | 26 | 27 | 29 | 29 | 26 | 24 |
| Evaluation | ∘ | ∘ | ∘ | ∘ | ∘ | x |

Average cell diameter

| | | | | | | |
|---|---|---|---|---|---|---|
| Value (μm) | 132 | 133 | 108 | 99 | 86 | 78 |
| Evaluation | x | x | ∘ | ∘ | ∘ | ∘ |

The results for Examples 4 to 6, Comparative Examples 3 and 4 and Conventional Example 3 shown in Table 4 indicate that the continuous crosslinking provides the same effect as the crosslinking in the vulcanization can.

The results for Examples 4 to 6 and Conventional Example 3 indicate that, where OBSH and sodium hydrogen carbonate are used in combination as the foaming agent and the tubular body is foamed at a heating temperature of not lower than 120° C. and not higher than 140° C. by the single-stage foaming process, it is possible to produce a transfer roller which is flexible and has an Asker-C hardness and an average cell diameter respectively falling within the aforementioned ranges, a lower rubber hardness and a smooth outer peripheral surface.

However, the results for Examples 4 to 6 and Comparative Examples 3 and 4 indicate that, in order to provide the aforementioned effect, the blending proportion of sodium hydrogen carbonate should be not less than 0.25 parts by mass and not greater than 2.5 parts by mass based on 1 part by mass of OBSH.

This application corresponds to Japanese Patent Application No. 2016-094776 filed in the Japan Patent Office on May 10, 2016 and Japanese Patent Application No. 2016-136911 filed in the Japan Patent Office on Jul. 11, 2016, the disclosures of which are incorporated herein by reference in their entireties.

What is claimed is:

1. A transfer roller comprising a foam formed from an electrically conductive rubber composition which comprises a rubber component, a crosslinking component for crosslinking the rubber component, and a foaming agent including 4,4′-oxybisbenzenesulfonylhydrazide (OBSH) and not less than 0.25 parts by mass and not greater than 2.5 parts by mass of sodium hydrogen carbonate based on 1 part by mass of 4,4′-oxybisbenzenesulfonylhydrazide (OBSH) for foaming the rubber component, the transfer roller having an Asker-C hardness of not lower than 25 degrees and not higher than 35 degrees and an average foam cell diameter of not greater than 120 μm.

2. The transfer roller according to claim 1, wherein the rubber component comprises ion-conductive epichlorohydrin rubber.

3. The transfer roller according to claim 2, wherein the rubber component comprises the epichlorohydrin rubber, and at least one rubber selected from the group consisting of styrene butadiene rubber, ethylene propylene diene rubber, acrylonitrile butadiene rubber, chloroprene rubber, butadiene rubber and acryl rubber.

4. The transfer roller according to claim 3, wherein the epichlorohydrin rubber is present in the rubber component in a proportion of not less than 20 parts by mass and not greater than 40 parts by mass based on 100 parts by mass of the overall rubber component.

5. The transfer roller according to claim 4, wherein the rubber component comprises an epichlorohydrin-ethylene oxide-allyl glycidyl ether terpolymer, the ethylene propylene diene rubber and the acrylonitrile butadiene rubber.

6. The transfer roller according to claim 1, wherein the rubber component comprises a rubber and an electrically conductive agent.

7. The transfer roller according to claim 6, wherein the rubber component comprises an ion-conductive rubber and an electrically conductive agent.

8. The transfer roller according to claim 7, wherein the electrically conductive agent comprises electrically conductive carbon black.

9. The transfer roller according to claim 8, wherein the electrically conductive carbon black comprises High Abrasion Furnace black.

10. The transfer roller according to claim 8, wherein the electrically conductive carbon black is present in the electrically conductive rubber composition in a proportion of not less than 5 parts by mass and not greater than 20 parts by mass based on 100 parts by mass of the overall rubber component.

11. The transfer roller according to claim 1, wherein the average cell diameter is not smaller than 82 μm.

12. A transfer roller production method comprising the steps of: extruding the electrically conductive rubber composition according to claim 1 into a tubular body; and maintaining the tubular body at a temperature of not lower than 120° C. and not higher than 140° C. in a vulcanization can by application of pressurized steam to foam the electrically conductive rubber composition at a single stage.

13. A transfer roller production method comprising the steps of: extruding the electrically conductive rubber composition according to claim 1 into a tubular body; and, while continuously transporting the tubular body through a continuous crosslinking apparatus including a microwave crosslinking device and a hot air crosslinking device, maintaining the tubular body at a temperature of not lower than 120° C. and not higher than 140° C. to foam the electrically conductive rubber composition at a single stage.
